(19) United States
(12) Patent Application Publication
(10) Pub. No.: US 2015/0163256 A1
(43) Pub. Date: Jun. 11, 2015

(54) GROUP TRAVEL PLANNING

(71) Applicant: Stefan FRANK, Belmont, MA (US)

(72) Inventor: Stefan FRANK, Belmont, MA (US)

(73) Assignee: GOOGLE INC., Mountain View, CA (US)

(21) Appl. No.: 13/600,014

(22) Filed: Aug. 30, 2012

(51) Int. Cl. H04L 29/06; G06Q 10/02; G06F 3/0482; G06F 17/30; G06F 3/0484

(52) U.S. Cl. CPC H04L 65/403; G06F 3/04842; G06F 3/0482; G06F 17/30876; G06F 17/30241

(57) ABSTRACT

Methods, systems, and apparatus, including computer programs encoded on a computer storage medium, for receiving user input specifying trip parameters for organizing a trip for a travel group, the trip parameters including a trip duration, trip category, and a social group; providing, to each member of the travel group, data identifying potential time periods and potential trip destinations, the potential trip destinations having been identified based in part on the specified trip duration and trip category; receiving, from one or more members of the travel group, selections specifying one or more time periods and one or more trip destinations; determining, based on the received selections, a particular time period and a particular trip destination for a trip; and generating, for one or more members of the travel group, a respective trip itinerary for the trip at the particular time period and to the particular trip destination.

### BACKGROUND

This specification relates to travel planning

Users can use maps of geographic regions to identify travel routes. Conventionally, a user can make travel plans using hardcopy or web-based maps of a geographic location. In some instances, users can use web sites containing web-based maps to identify an itinerary for travel (e.g., a particular travel route) or hotel locations.

### SUMMARY

In general, one aspect of the subject matter described in this specification can be embodied in methods that include the actions of receiving, through a client device, user input from a user specifying trip parameters for organizing a trip for a travel group, the trip parameters including a trip duration, trip category, and a social group, wherein the social group includes one or more contacts of the user, and wherein the travel group includes as members the user and the one or more contacts in the social group; providing, to each member of the travel group, data identifying one or more potential time periods and one or more potential trip destinations, the potential trip destinations having been identified based in part on the specified trip duration and trip category; receiving, from one or more members of the travel group, selections specifying one or more time periods and one or more trip destinations; determining, based on the received selections, a particular time period and a particular trip destination for a trip; and generating, for one or more members of the travel group, a respective trip itinerary for the trip at the particular time period and to the particular trip destination. Other embodiments of this aspect include corresponding systems, apparatus, and computer program products.

These and other embodiments can optionally include one or more of the following features. Generating, for one or more members of the group, a respective trip itinerary at the particular time period and to the particular trip destination includes receiving, from one or more members of the group, confirmations committing to the trip at the particular time period and the particular trip destination; and in response to receiving confirmations from the one or more members, generating, for the one or more members, the respective trip itinerary. Generating, for one or more members of the group, a respective trip itinerary at the particular time period and to the particular trip destination includes identifying one or more members of the group that selected a time period and trip destination that matches both the particular time period and the particular trip destination; and in response to identifying the one or more members, generating, for the one or more members, the respective trip itinerary for the trip. The particular time period and the particular trip destination are determined by the user. The particular time period and the particular trip destination are determined based on a respective count of selections received for the particular time period and the particular trip destination.

Data identifying one or more potential time periods for the trip and one or more potential trip destinations is provided on a travel planning interface, the travel planning interface including a calendar portion and a potential trip destinations portion, the calendar portion indicating one or more potential time periods for attending the trip, and the potential trip destinations portion describing one or more trip destinations that were identified based on the specified trip duration and trip category. The potential trip destinations portion includes, for each of the one or more trip destinations, a respective popularity vote and a respective average travel cost, where the respective popularity vote is based on selections received, from one or more members of the group, for the one or more trip destinations. The travel planning interface includes a map portion, the map portion indicating locations of the one or more members of the group, and a location of the particular trip destination. The method further includes receiving user input from a member of the group, the user input specifying a new trip destination in the map portion; and providing data identifying the new trip destination to the one or more members of the group. The trip parameters further include a time range, wherein the time range specifies a proposed range of time within which the trip should occur.

Other embodiments of this aspect include corresponding systems, apparatus, and computer program products.

In general, another aspect of the subject matter described in this specification can be embodied in methods that include the actions of receiving, through a client device, a user selection of an endorsement option, the endorsement option being associated with a particular geographic entity, and user input specifying parameters for organizing a trip for a travel group; in response to receiving the user selection and input, generating, for the travel group, one or more respective trip itineraries for a trip located at the particular geographic entity; and providing, to the travel group, the one or more respective trip itineraries, wherein the respective trip itineraries include proposed flights and hotel bookings for one or more time periods.

These and other embodiments can optionally include one or more of the following features. The respective trip itineraries are provided in a post on a social site. The particular geographic entity is a particular hotel or a point of interest. The specified parameters include a trip duration and a social group, wherein the social group includes one or more contacts, and wherein the travel group includes as members the user and the one or more contacts of the social group. The method further includes receiving, from one or more first members of the group, selections for one or more trip itineraries; determining, based on the received selections, a particular time period for the trip; and providing, to the one or more first members of the group, respective trip itineraries for the particular time period. The particular time period is determined by the user. The particular time period is determined based on a count of selections received for trip itineraries for the particular time period.

Other embodiments of this aspect include corresponding systems, apparatus, and computer program products.

Particular embodiments of the subject matter described in this specification can be implemented so as to realize one or more of the following advantages. A user can plan and coordinate a trip with one or more contacts, e.g., individuals, groups, organizations, using a travel planning interface. Potential geographic destinations for the trip can be identified based on travel times and trip category that are specified in the travel planning interface. Group trips can be coordinated by selecting an endorsement option on a web page associated with a particular geographic entity.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example travel planning system.

FIG. 2 is a flow diagram of an example process for organizing group travel.

FIG. 3 is an example group travel planning interface for planning a trip.

FIG. 4 is an example group travel planning interface for selecting time periods for a trip.

FIG. 5 is an example group travel planning interface for selecting trip destinations for a trip.

FIG. 6 is a flow diagram of another example process for organizing group travel.

FIG. 7 illustrates a web page for a geographic entity including an endorsement option for organizing a group trip.

FIG. 8 illustrates a travel planning overlay in a web page for a geographic entity for organizing a group trip.

FIG. 9 illustrates a post in a social networking page providing trip itineraries for a group member.

FIG. 10 illustrates an example trip photo wall.

FIG. 11 illustrates an example travel companion interface displaying a real-time travel status for members of a group trip.

FIG. 12 illustrates an example travel companion map interface displaying real-time locations of members of a group trip.

Like reference numbers and designations in the various drawings indicate like elements.

### DETAILED DESCRIPTION

A user can plan and coordinate a group trip with their contacts using a travel planning interface. The contacts can be social contacts, e.g., individuals, groups, or organizations, and can be identified through a social site. The user can specify trip parameters in the travel planning interface, including a trip duration, trip category, and a travel group. Potential geographic destinations for the group trip can be identified based on the specified trip parameters. Group members of the travel group can vote on time periods and destinations for the group trip. Based on the votes, a group trip for a particular destination and during a particular time period can be determined. A customized trip itinerary for each group member can be generated. The customized trip itineraries can include, for example, flight and hotel reservations for the group members.

A user can also plan and coordinate a group trip by selecting an endorsement option that is associated with a geographic entity, e.g., a resort or a point of interest, and by specifying parameters for organizing a trip for a travel group. Based on the selected endorsement option and the specified parameters, customized trip itineraries can be generated for each group member of the travel group. The customized trip itineraries can be presented to the group members and the group members can select preferred flights, hotels, or time periods for attending the group trip.

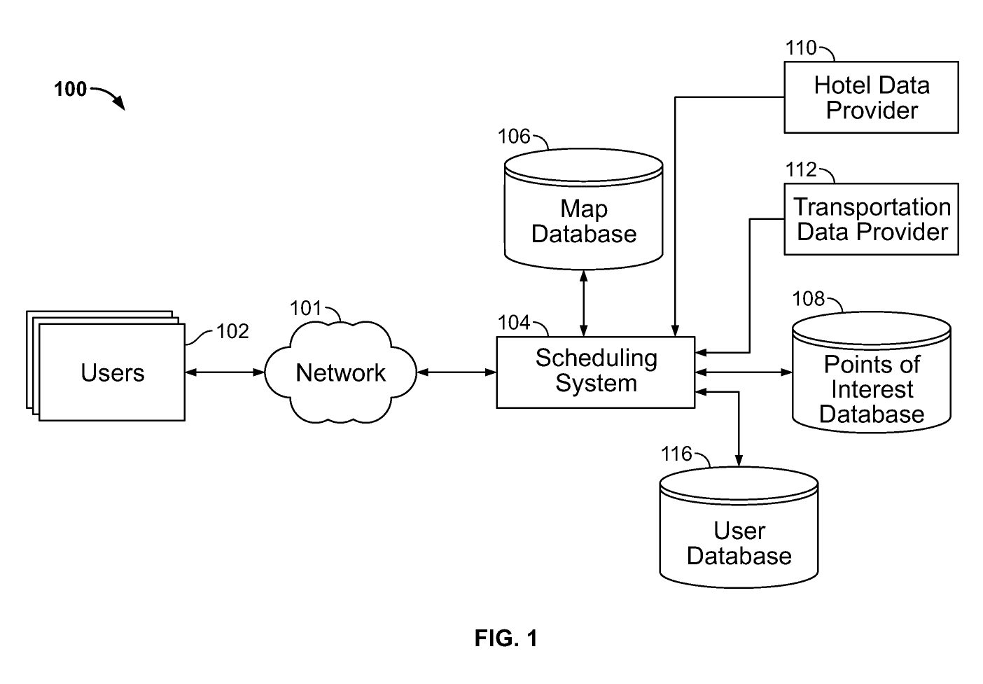

FIG. 1 is a block diagram of an example travel planning system 100. The travel planning system 100 includes a scheduling system 104 in communication with one or more users 102 through a network 101. The scheduling system 104 receives information from a map database 106 to display maps for geographic regions. The map database 104 can store, for example, data identifying different types of maps for geographic regions, e.g., two-dimensional maps, three-dimensional maps, or satellite maps.

Additionally, the scheduling system 104 obtains information pertaining to points of interest from a points of interest database 108. The points of interest database 108 can store, for example, data identifying points of interests in geographic regions. Points of interest can include places visited by tourists, places visited by locals, restaurants, shopping locations, entertainment locations, and particular geographic locations of interest. The points of interest can be identified using various methods, e.g., using geotagged information from images, business classification data, location-based services, and user reviews. In some implementations, data identifying points of interest are associated with a category that describes the respective points of interest. For example, a museum can be categorized as “educational,” a state beach can be categorized as a “beach,” and a casino can be categorized as “entertainment.” Other example categories include recreational, party, fun, remote location, or exotic location.

The scheduling system 104 can communicate with a hotel data provider 110 to obtain hotel information describing hotels in various geographic regions, corresponding pricing information, dates of availability, location, descriptions, amenities, class, and reviews. In particular, the scheduling system 104 can identify one or more hotels that are located near a particular point of interest. For example, the scheduling system 104 can identify one or more hotels that are located within a specified distance from a particular point of interest. The term “hotel” as used in the specification can refer generically to various types of accommodations including hotels, motels, lodges, or resorts.

The scheduling system 104 can communicate with a transportation data provider 112 to obtain transportation options for traveling from a first location to a second location, e.g., transportation options for traveling from a user's location to a point of interest. In some implementations, the transportation data provider 112 provides flight scheduling information for various geographic regions, corresponding pricing information, and dates of availability. The scheduling system 104 can be configured to book transportation options. Alternatively, the scheduling system 104 can communicate with the transportation data provider 112 to book transportation options. Additionally, the scheduling system 104 and the transportation data provider 112 can be configured to coordinate other types of transportation, e.g., cruises, trains, buses, shuttles, taxis, and rental cars.

The scheduling system 104 can obtain data provided by users, e.g., in a social networking web site, from a user database 116. The user database 116 can store data identifying attributes for individual users, e.g., social profiles, e-mail addresses, location of residence, calendar information, airport preferences, airline preferences, hotel preferences, and transportation preferences. Each user's social profile can include a set of associated contacts, a set of links to external resources, e.g., web pages, and subscriptions to content of the system, e.g., a system that provides various content and applications including e-mail, chat, video, photo albums, or blogs. A user's contacts can be identified based on social profiles that are linked to a social profile associated with the user. Users can further organize their contacts into particular groups, e.g., social groups. For example, a user can categorize one or more contacts into a “travel group.”

The network 101 can be a local area network (LAN), a wide area network (WAN), the Internet, one or more telephony or wireless networks, or a combination thereof.

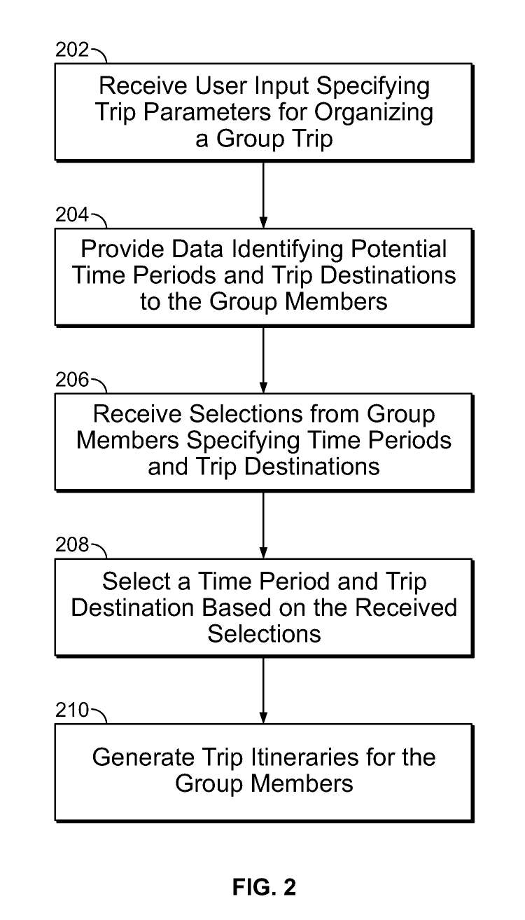

FIG. 2 is a flow diagram of an example process for group travel planning. For convenience, the process 200 will be described with respect to a system (e.g., scheduling system 100) including one or more computing devices that performs the process 200.

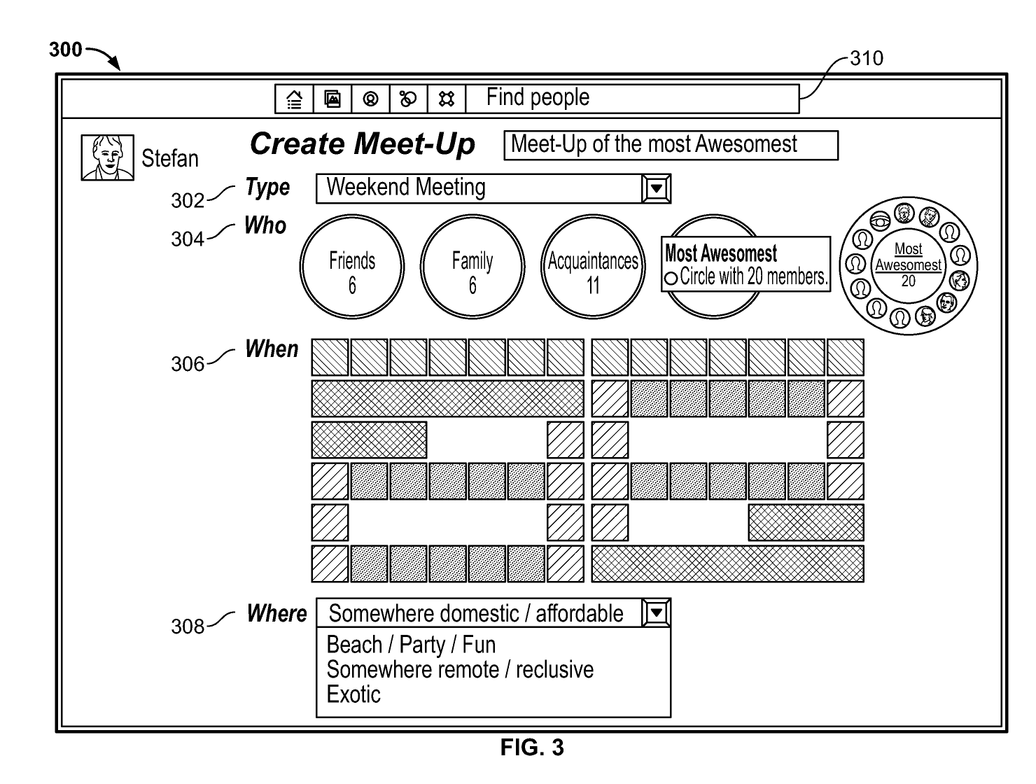

The system receives user input specifying trip parameters for organizing a trip for a group (202). The trip parameters can be received from a client device communicating over a network. The user can specify the trip parameters in a graphical user interface (GUI), e.g., the GUI described below in reference to FIG. 3.

In some implementations, the trip parameters include a trip duration, trip category, and a social group. The trip duration indicates a length of time for the trip and can be specified according to a unit of time, e.g., a specified number of hours or days. The trip duration can also be specified according to a segment of time, e.g., a weekend, a holiday weekend, one or more weeks, months, or years. Optionally, a time range can be specified to limit the range within which the trip should occur. For example, a time range of two months indicates that the trip, having the specified duration, can occur to within two months of the date the user begins planning the trip, e.g., a weekend within two months from the time the system receives the user input. The time range can also be specified as a particular day, week, month, or year. For example, the user can specify the time range as “September” to indicate that the trip should occur sometime in the month of September.

A trip category generally describes the type of trip being planned. For example, the user can specify that the trip be educational, recreational, entertainment-related, at a beach, party-related, fun, at a remote location, or at an exotic location. In some implementations, the system identifies one or more potential trip destinations based on the specified trip category, as described below.

In some implementations, a trip category can be optimized based on travel time and/or cost for the members attending the trip. For example, the user can specify a “beach” trip category and can also specify the trip be optimized by cost for the members attending. In response, the system can identify one or more trip destinations that qualify as “beach” trips and are also lower in cost, for each member attending the trip, relative to other trip destinations that qualify as “beach” trips. In optimizing costs, the system can consider both transportation costs, e.g., flights, and hotel costs. Similarly, the system can optimize trip destinations based on travel time, e.g., identify trip destinations that are within six hours of travel time for each member attending the trip.

The user also defines the travel group for which the trip is being organized. Generally, the group includes as members the user and one or more social groups that the user wants to include in the trip. Alternatively, the system can be configured so that the user serves as a trip organizer for the user's contacts without necessarily being included in the group.

In some implementations, the user specifies a trip location in lieu of a trip category and the system can coordinate a trip with the group at the specified trip location. For example, the user can specify a trip location of Cancun, Mexico, and the system can coordinate travel to Cancun, Mexico for the group.

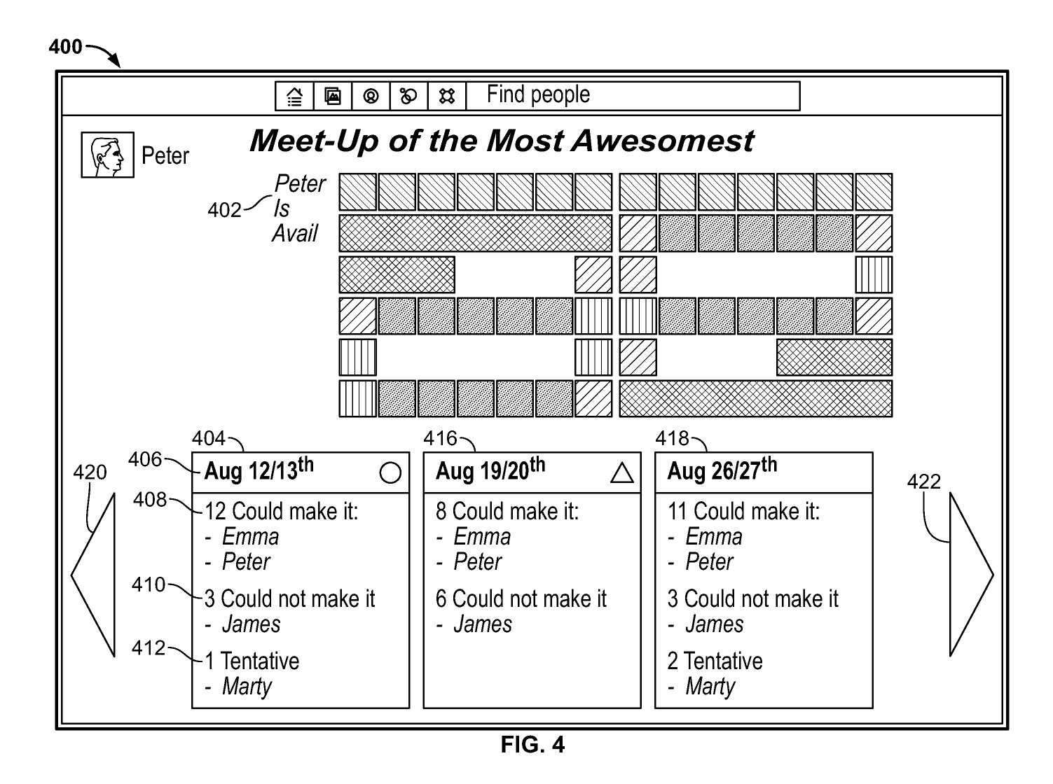

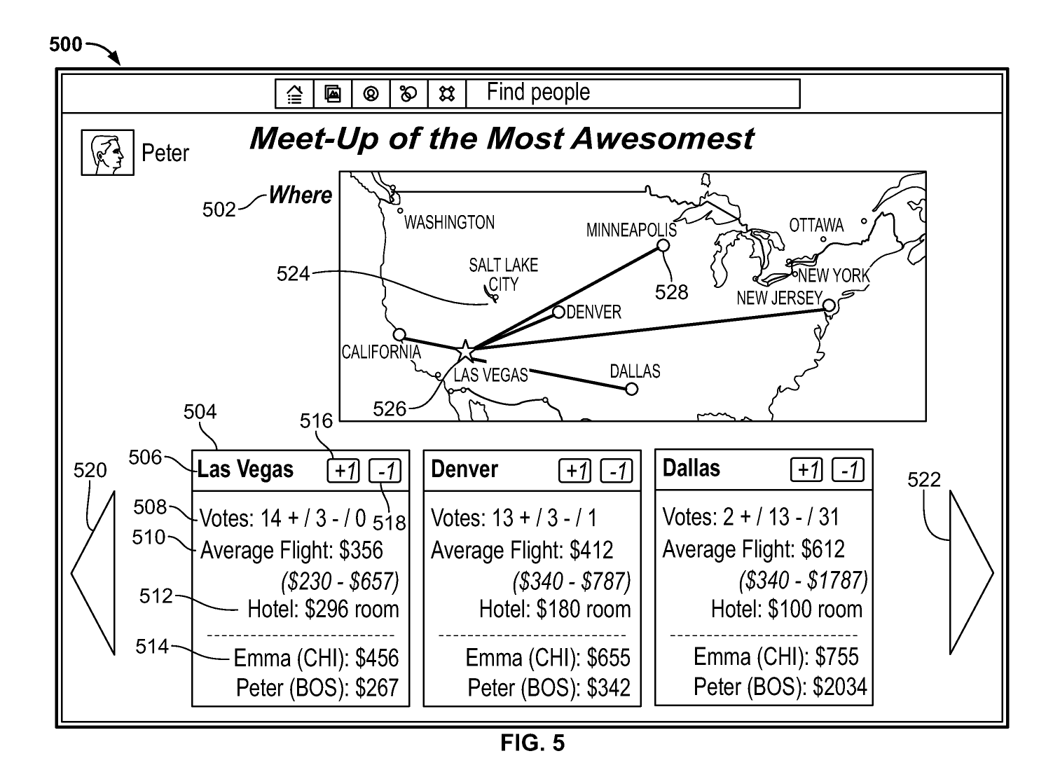

The system provides, to each member of the group, data identifying one or more potential time periods and one or more potential trip destinations (204). Time periods and potential trip destinations for the trip can be provided in a graphical user interface (GUI), e.g., the GUIs described below in reference to FIGS. 4 and 5.

In some implementations, the potential time periods correspond to the specified time duration. For example, if the time duration is specified as a “weekend”, then the potential time periods for the trip will be one or more upcoming weekends. The system can identify one or more potential time periods up to a range, e.g., one or more weeks, months, or years. For example, the system can use a timestamp of when the user input was received as a reference point and can identify one or more upcoming weekends for the trip, up to six months beyond the timestamp. In some implementations, the user specifies a time range to indicate a proposed range within which the trip should occur. For example, using a specified time range of two months, the system can identify one or more upcoming weekends for the trip within two months of a timestamp of when the user input was received.

In some implementations, the potential time periods are optimized based on the schedules of the members of the group. For example, time periods that conflict with the schedules of one or more members can be omitted from the list of potential time periods. Member schedules can be obtained, for example, by accessing user calendar data stored in the user database 116, as described in reference to FIG. 1.

The system can also identify one or more potential trip destinations for the trip. In some implementations, the trip destinations are identified based on the specified trip category. The system can identify one or more trip destinations from the points of interest database 108, as described in reference to FIG. 1, by identifying points of interest that are associated with a category that matches the specified trip category. For example, if the user specifies “party” as a trip category, the system can identify geographic locations that have been classified as “party” destinations, e.g., Las Vegas, Nev. and Miami, Fla.

In some implementations, the user geographically restricts the potential trip destinations, for example, restricted to domestic locations, foreign locations, or regions. The restriction can be specified by user input identifying one or more geographic parameters e.g., zip code, city, state, country, continent. In some implementations, the user optionally restricts the potential trip destinations by cost, e.g., locations having transportation and lodging costs for the group members that are below a specified cost, for example, per night lodging maximum or trip maximum.

The system receives, from one or more members of the group, selections specifying one or more time periods and one or more trip destinations (206). The members can specify selections of time periods and trip destinations in a graphical user interface (GUI), e.g., the GUIs described below in reference to FIGS. 4 and 5. Additionally, the members can commit to one or more time periods and one or more trip destinations. Committing to a time period or trip destination can provide an indication that a member is prepared to attend a trip at a particular time period or trip destination.

The system determines a particular time period and a particular trip destination based on the received selections (208). In some implementations, the determination is based on a user selection of a particular time period and particular trip destination for the trip. For example, the user can view the selections received from the group members to determine a best time and destination for the trip. In some implementations, the determination is based on the system selecting a particular time period and the particular trip destination for the trip.

The system can select the particular time period and the particular trip destination based on a respective count of selections received from the one or more members of the group. For example, the system can select a time period that received the largest quantity of selections in comparison to the other time periods. For example, if 10 members selected a time period of May 5-6 and 3 members selected a time period of May 19-20, then the system can select the time period of May 5-6. Similarly, the system can select a trip destination that received the largest quantity of selections in comparison to the other trip destinations. In some implementations, a member of the group selects a time period and trip destination. After a particular time period and a particular trip destination have been selected, each member in the group can commit to the trip, e.g., by selecting a commit option in the GUI described in reference to FIGS. 4 and 5.

The system generates respective trip itineraries for one or more members of the group (210). In some implementations, the system generates respective trip itineraries for each member of the group that has committed to the trip. A trip itinerary is customized for each committed member. For example, the system can customize trip itineraries using information obtained from the user database 116, hotel data provider 110, and transportation data provider 112. Based on the obtained information, the selected time period, and the selected trip destination, the system can identify one or more transportation options originating from a member's residence to the selected trip destination. For example, the system can identify transportation options to the airport, flights to the trip destination, and transportation to a hotel near the trip destination. The system can also identify one or more reservations for hotels that are located near the trip destination. In some implementations, the system identifies members of the group that selected a time period and trip destination that matches both the selected time period and trip destination, and generates a respective trip itinerary for the identified members.

The system can provide the respective trip itineraries to members committed to the trip. The members can customize their trip itineraries, e.g., by selecting particular airlines, outbound and inbound legs and selecting particular hotels and hotel options. In some implementations, the members can collaborate with one another to coordinate sharing of lodging. For example, when customizing a trip itinerary, a member can specify that they want to share a hotel room with one or more other members. In response, the system can modify the trip itineraries of the members sharing the hotel room so that a shared room is booked. In such implementations, one member can be billed for the shared room. Alternatively, the system can be configured to bill the members in the shared room in equal parts, or in some other specified proportion.

In some implementations, the members can book their trip itineraries, e.g., by selecting a confirmation option in the GUIs described in reference to FIGS. 4 and 5. In some implementations, the system directs the members to a selected booking site for booking their itineraries. In particular, a given trip itinerary can be provided along with one or more links to booking sites. Each reference to a particular booking site can include the corresponding price for the itinerary, e.g., flight and hotel costs. The user can then complete the purchase of the itinerary through the booking site.

FIG. 3 is an example group travel planning interface 300 for planning a trip. The group travel planning interface 300 includes a trip duration drop-down menu 302, a social group menu 304, a calendar portion 306, a trip category drop-down menu 308, and a contact search box 310.

The trip duration drop-down menu 302 includes segments of time indicating a duration for the trip. For example, using the drop-down menu 302, a user can specify that the trip be over a weekend, a holiday weekend, one or more weeks, months, or years. In some implementations, the user can specify a length of time as the trip duration, e.g., a specified number of hours, days, weeks, months, or years.

The social group menu 304 displays social groups that are associated with the user's social profile. The user can select one or more of the social groups to define a travel group for which the trip is being organized. The social group menu 304 displays names for the social groups and counts of the user's contacts that are in the respective social groups. Alternatively, the user can search for certain individuals or social groups to be included in the trip using the contact search box 310. Additionally, the user can create a new social group specifically for the trip and add certain individuals and social groups to the new group.

The calendar portion 306 displays dates available in a particular range. For example, the calendar portion 306 can include a date box for each day in a two-month date range, e.g., starting from a date on which the user begins planning the trip. The user can interact with the date box to select a date range within which the trip should occur. For example, assuming the calendar portion shows dates for the months of June and July, the user can specify that the trip should occur within the first three weeks of June. The user can adjust the range displayed in the calendar portion 306 to view other available dates. For example, the user can adjust the calendar portion 306 showing dates for the months of June and July to view dates in preceding or subsequent months, e.g., May or August.

The user can select a category from the trip category drop-down menu 308 to specify the type of trip being planned. Some example categories that can be included in trip category drop-down menu 308 are educational, recreational, entertainment-related, at a beach, party-related, fun, at a remote location, at an exotic location, domestic location, and affordable location. The category specified in the trip category drop-down menu 308 can be used to identify one or more potential trip destinations, as described above.

FIG. 4 is an example group travel planning interface 400 for selecting time periods for a trip. The group travel planning interface 400 includes a calendar portion 402 and a time period summary portion 404. In some implementations, the group travel planning interface 400 for selecting time periods is provided to each member of a group that is attending the trip.

The calendar portion 402 displays a range of potential time periods for attending the trip. The calendar portion 402 can be color-coded to signify the potential time periods. For example, when a weekend trip is being planned, dates that represent weekends can be highlighted in the calendar portion 402. A member can interact with the calendar portion 402 to select one or more preferred time periods for attending the trip. For example, the member can click on date boxes in the calendar portion 402 to select one or more preferred time periods. The member can also interact with the calendar portion 402 to designate their availability, e.g., unavailable or tentative, for one or more time periods. Other potential time periods can be accessed in the group travel planning interface 400 using the previous 420 and next 422 arrows.

The time period summary portion 404 includes summary boxes 406, 416, and 418, for each of the potential time periods. Each summary box includes information relating to a respective time period. For example, the summary box 406 includes information indicating the time period “August 12/13”. The summary box 406 also includes availability information for members of the group. For example, the summary box 406 indicates a count of members that have indicated that they are available for the time period 408, a count of members that have indicated that they are unavailable for the time period 410, and a count of members that are tentative for the time period 412. The availability information can also include names of the members along with their availability. For example, the member “Marty” is listed under the count of members that are tentative for the time period 412.

FIG. 5 is an example group travel planning interface 500 for selecting trip destinations for a trip. The group travel planning interface 500 includes a map portion 502 and a trip destinations summary portion 504. In some implementations, the group travel planning interface 500 for selecting trip destinations is provided to each member of a group that is attending the trip. Other potential time destinations can be accessed in the group travel planning interface 500 using the previous 520 and next 522 arrows.

The map portion 502 indicates geographic locations of the members of the group, e.g., location 528 indicating one or more members are located in Minneapolis, Minn. The map portion 502 also indicates a geographic location of a potential trip destination 526. In some implementations, the map portion 502 indicates a geographic location of a trip destination 526 having the largest number of preferred votes. In some implementations, a member of the group can suggest a trip destination that is different than the potential trip destinations that are provided in the travel planning interface 500. For example, the member can select a different trip destination on the map portion 502, e.g., “Salt Lake City, Utah” 524, and the travel planning interface 500 can be updated to provide the suggested trip destination in the list of potential trip destinations.

The trip destinations summary portion 504 includes summary boxes, e.g., summary box 506, for each of the potential trip destinations. Each summary box includes information relating to a respective trip destination. For example, the summary box 506 includes information indicating the trip destination “Las Vegas”. The summary box 506 also includes voting information 508 indicating a popularity for the respective trip destination. The voting information 508 indicates a count of member votes that prefer the trip destination, a count of member votes that do not prefer the trip destination, and a count of member votes that are undecided on the trip destination. A member can interact with the travel planning interface 500, e.g., using voting buttons 516 and 518, to vote, respectively, for or against a particular trip destination.

Additionally, the summary box 506 includes transportation 510 and lodging 512 information for the respective trip destination. For example, the summary box 506 indicates that the average cost for a flight to the trip destination for the members of the group is $356, with flight costs ranging from $230 to $657. The summary box 506 also indicates an average cost for a hotel reservation 512 for members of the group. Individual flight costs 514 for each of the members to the trip destination can also be displayed in the summary box 506. In some implementations, the summary boxes are customized to display transportation and lodging costs for one or more group members. In some implementations, the summary boxes are customized to display transportation and lodging costs for the group member that is accessing the group travel planning interface 500.

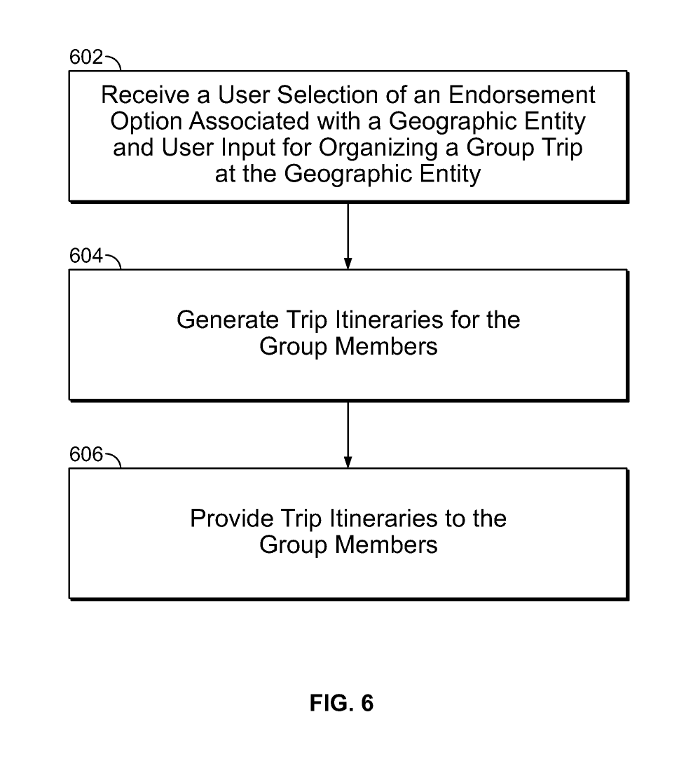

FIG. 6 is a flow diagram of another example process for group travel planning. For convenience, the process 600 will be described with respect to a system (e.g., scheduling system 100) including one or more computing devices that performs the process 600.

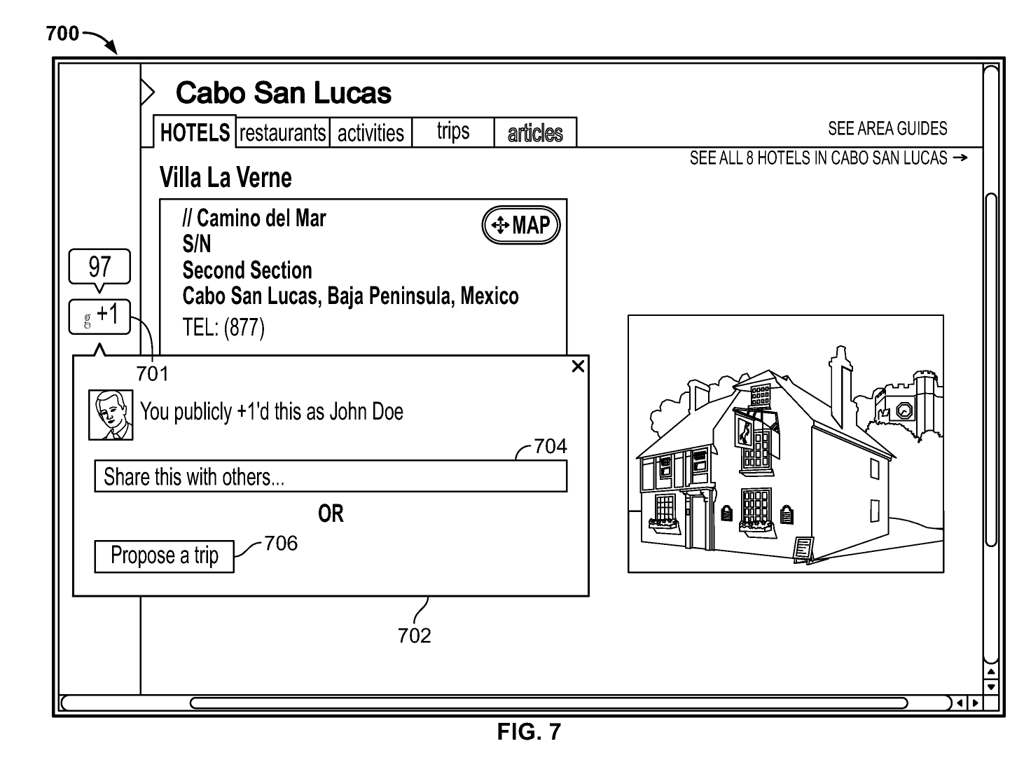

The system receives, from a user, a user selection of an endorsement option, the endorsement option being associated with a particular geographic entity, and user input specifying parameters for organizing a trip for a group (602). The trip parameters can be received from a client device communicating over a network. The user can specify the trip parameters in a graphical user interface (GUI), e.g., the GUI described in reference to FIGS. 7-9.

Endorsement options can be included on sites, e.g., web pages that relate to geographic entities, for example, a web page for a resort or point of interest. Each endorsement option can be associated with a respective geographic entity, such that a geographic entity can be identified when a corresponding endorsement option is selected. The user can organize a group trip at a particular geographic entity by selecting an endorsement option that corresponds to the particular geographic entity, as described in reference to FIG. 7. Some example geographic entities include hotels, resorts, and other points of interest, e.g., museums, theme parks, national parks, cities, states, countries, and continents. For example, a web site for a particular resort in Hawaii can include an endorsement option that allows the user to organize a group trip to the resort.

In some implementations, the user specifies parameters for the trip, including a trip duration and a social group to include in the trip planning. The trip duration indicates a length of time for the trip and can be specified according to a unit of time, as described in reference to FIG. 2. In some implementations, the travel group for which the trip is being organized includes as members the user and one or more social groups that the user wants to include in the group. Alternatively, the system can be configured so that the user serves as a trip organizer for the user's contacts without necessarily being included in the travel group.

The system generates respective trip itineraries for the group (604). Trip itineraries are customized for each group member, i.e., a trip itinerary for a particular group member includes proposed time periods for the trip, transportation options, e.g., proposed flights, for traveling from the member's residence to the particular geographic entity, as well as lodging options at or near the particular geographic entity.

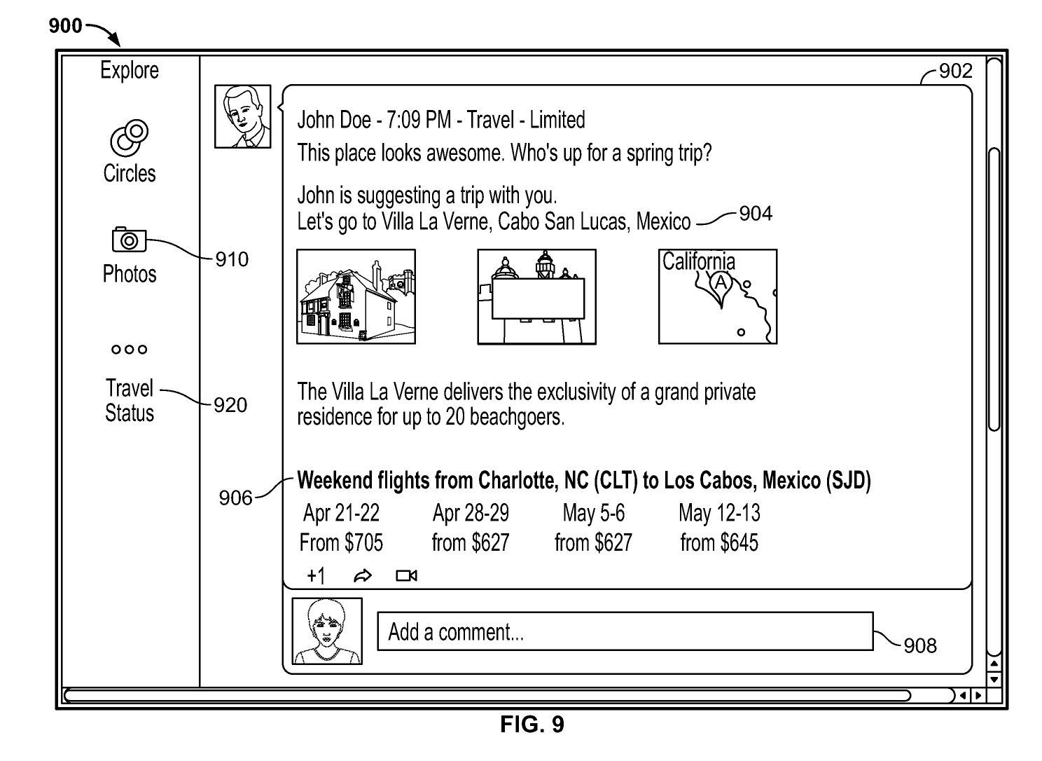

The system provides the trip itineraries to the group (606). Trip itineraries can be provided to group members in an interface that is similar to the travel planning interface described in reference to FIGS. 4 and 5. In some implementations, trip itineraries are provided to the group members in a post on a social site, as described below in reference to FIG. 9. The trip itineraries can also be provided using other communication mediums, e.g., e-mail or text message.

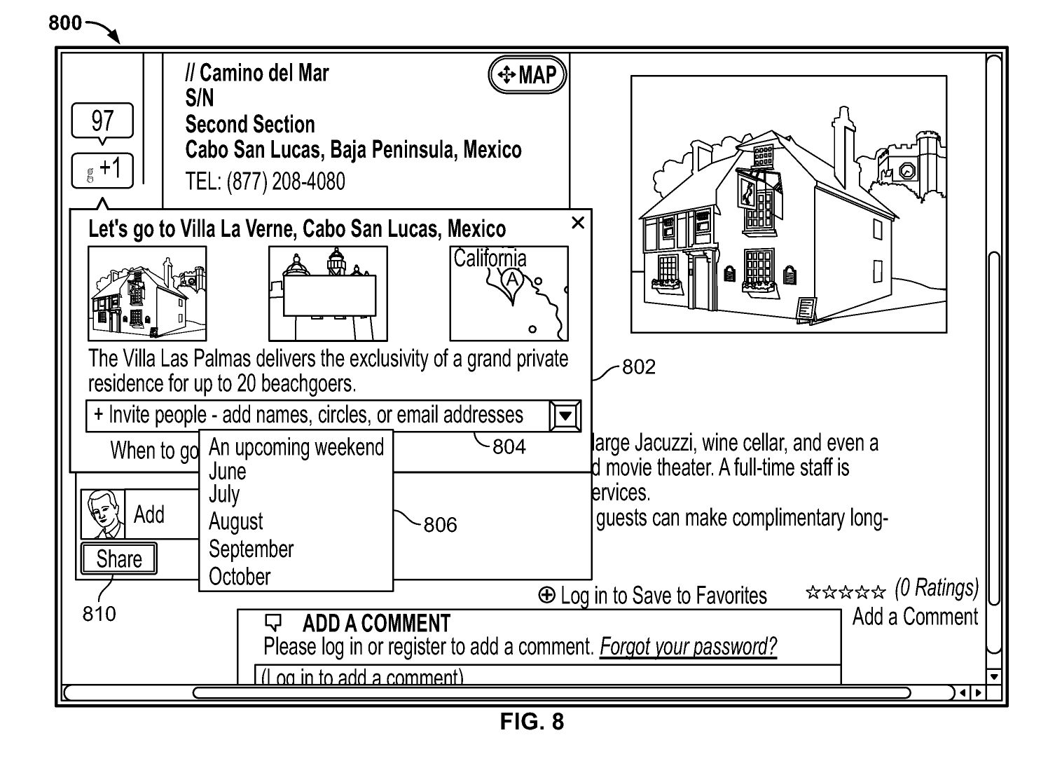

FIG. 7 illustrates a web page 700 for a geographic entity, i.e., a hotel in Cabo San Lucas, including an endorsement option 701 for organizing a group trip at the hotel. A user can organize a group trip at a particular geographic entity by selecting the endorsement option 701. In some implementations, selecting the endorsement option 701 provides the user with one or more options relating to the hotel. For example, the user can share the web page describing the hotel by adding social groups or contacts in the share box 704. The user can also select a propose trip option 706 to organize a trip at the hotel, as described in reference to FIG. 8. In some implementations, selection of the endorsement option 701 results in organizing a trip at the geographic entity.

FIG. 8 illustrates a travel planning overlay 802 in a web page for a geographic entity, i.e., a hotel in Cabo San Lucas, for organizing a group trip at the hotel. The travel planning overlay 802 can be displayed in response to selecting the endorsement option, as described in reference to FIG. 7. The travel planning overlay 802 can provide information relating to the trip, including the name, address, and description of the geographic entity at which the trip will be held. A user can interact with the travel planning overlay 802 to specify parameters for the group trip. In some implementations, the user can interact with the travel planning overlay 802 to specify a trip duration, a trip range, and a group, e.g., social groups or contacts.

In some implementations, a drop-down menu 804 is be used to add or remove social contacts or groups to the group for the trip. Contacts can be added based on their respective names, user names, existing social groups, or e-mail addresses. In some implementations, a search box is used to search for and add social contacts and groups as members of the travel group.

In some implementations, the trip duration is specified in a drop-down menu 806. The drop down-menu 806 includes segments of time indicating a duration for the trip, e.g., “an upcoming weekend”. In some implementations, the user can specify a trip range using the drop-down menu 806, e.g., by selecting June, July, August, September, or October, and trip itineraries can be generated for a segment of time within the selected trip range.

For example, the user can select, in the drop-down menu 806, the month of June, and one or more trip itineraries can be generated for various segments of time, e.g., a weekend trip or a week-long trip, in the month of June. The trip itineraries can be optimized to select segments of time within the specified trip range by cost, e.g., segments of time having a lowest average cost to the group or segments of time having a cost that is below a threshold cost for each group member. In some implementations, the travel planning overlay 802 includes a separate trip range drop-down menu that provides segments of time, e.g., a particular date, week, month, or year for when the trip should occur.

The user can propose the trip to the group, i.e., to the members identified using the drop-down menu 804, once the parameters have been specified. In some implementations, the trip is proposed to the group when the user selects a share option 810. The trip can be proposed to the group in a post on a social site, as described in reference to FIG. 9, or in an e-mail. In some implementations, customized trip itineraries are generated for each member in the group as part of the trip proposal. For example, a customized trip itinerary includes proposed time periods for the trip, transportation options, e.g., proposed flights, for traveling from the member's residence to the particular geographic entity, as well as lodging options at or near the particular geographic entity. The members can select one or more of the customized trip itineraries to vote for particular time periods for the trip. A particular time period for the trip can be determined based on the member selections. In some implementations, the time period for the trip is determined by a user selection of a particular time period. In some other implementations, the time period for the trip is determined based on a system selecting a particular time period, e.g., based on a count of selections received from the members.

FIG. 9 illustrates a post 902 in a social page 900 providing trip itineraries for a group member. The post 902 includes information relating to a proposed trip 904 and one or more trip itineraries 906 for the group member. As illustrated, the post 902 includes information describing a name, description, images, and location for the trip 904. The trip itineraries 906 provide a time period, e.g., “April 21-22”, and associated costs, e.g., transportation and lodging costs, for the proposed trip. Group members can select one or more trip itineraries based on their respective time periods.

A user organizing the trip can select a particular time period for the trip based on the trip itinerary selections made by the group members. Alternatively, a system can select a particular time period having the largest quantity of selections, i.e., the largest count of selections received for trip itineraries for the particular time period.

Upon selecting a particular time period, e.g., “April 21-22”, trip itineraries corresponding to the particular time period can be provided to the group members for confirmation. For example, the group member can be provided one or more trip itineraries for a time period “April 21-22”. The group member can confirm a trip itinerary by selecting the trip itinerary in the post 902. After confirming, the trip itinerary can be booked, as described above.

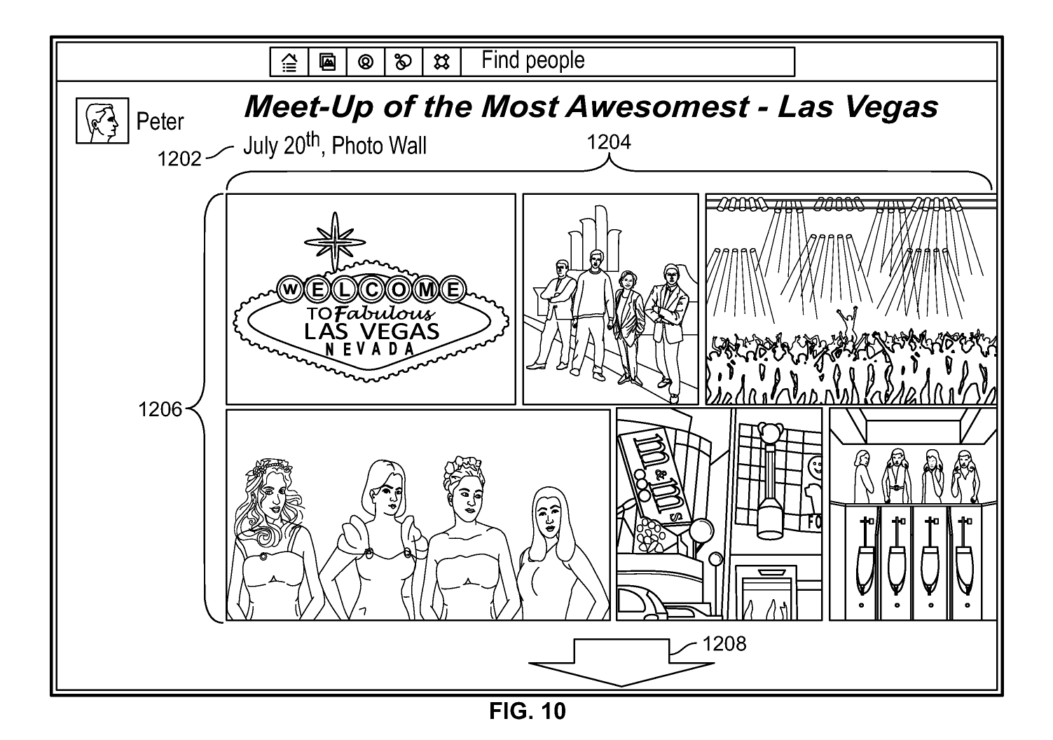

The social page 900 also includes a comment box 908 that is associated with the post 902 and a photos option 910. Group members can communicate with other members by inputting text in a comment box 908. In some implementations, photos taken by group members during the trip can be collected. The collected photos can be used, for example, to create a trip photo wall, as described in reference to FIG. 10. Group members can access the trip photo wall using, e.g., the photo option 910.

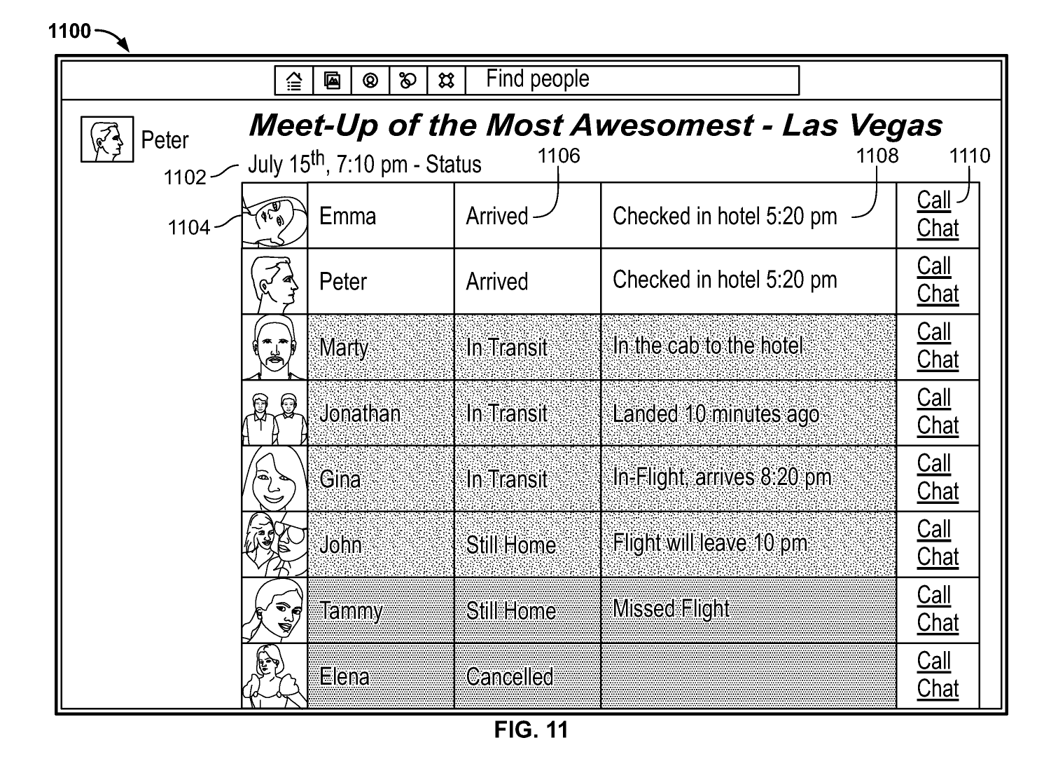

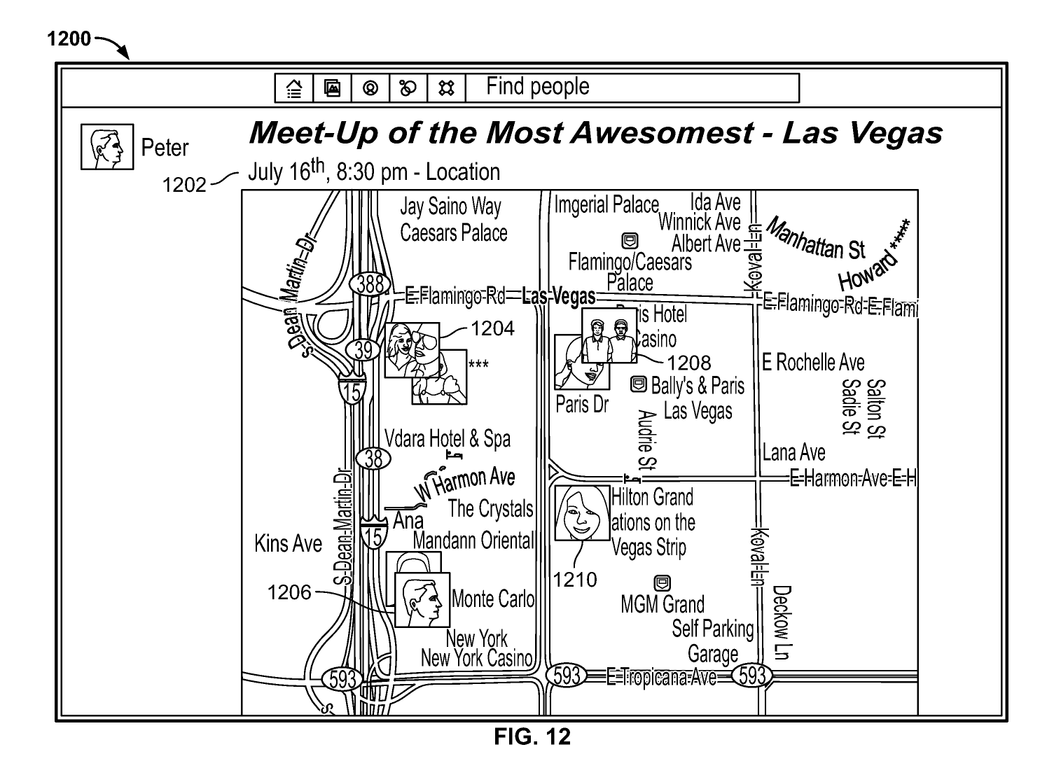

In some other implementations, group members can access a travel companion interface for use in determining a location and status of group members. For example, group members can select an option 920 to view a status of other group members, as described in reference to FIGS. 11 and 12.

FIG. 10 illustrates an example trip photo wall 1002. In some implementations, photos taken by group members are provided to a social site. The trip photo wall 1002 can be generated by the social site using the provided photos. In some implementations, the trip photo wall 1002 is sized based on predefined horizontal 1004 and vertical 1006 dimensions and photos are selected and arranged within the predefined horizontal 1006 and vertical 1006 dimensions, e.g., as a photo collage. Photos provided by a group member to a social site can be selected for inclusion in the trip photo wall 1002 based on the privacy settings of the group member. For example, if privacy settings allow, photos provided to the social site can be automatically selected for inclusion in the trip photo wall. In some other implementations, a group member can specify one or more photos for inclusion in the trip photo wall 1002. A control, e.g., an arrow 1008, can be selected to view additional photos, e.g., by other group members, that have been included in the trip photo wall 1002.

FIG. 11 illustrates an example travel companion interface 1102 displaying a real-time travel status for members of a group trip. The travel companion interface 1102 provides a group member name, travel status 1106, a status description 1108, and one or more options 1110 for contacting the group member. The travel status 1106 provides a status of where a group member is located in relation to a trip destination. For example, the travel status can indicate that a group member has arrived at a trip destination, is in transit to the trip destination, is still at home, or has cancelled their trip.

The status description 1108 can provide a more detailed explanation of a group members travel status. For example, the status description 1108 can provide a timestamp of when a group member checked into their hotel room, where a group member is in relation to their hotel, e.g., in a cab or in a flight. The status description 1108 can further provide an estimated time of arrival to the hotel, e.g., in a cab to the hotel and estimated arriving in 10 minutes. The status description 1108 can also provide flight status information and arrival times, e.g., landed 10 minutes ago; in-flight, arrives 8:20 pm; flight will depart at 10 pm; or, if a group member has missed their flight, the flight status information can indicate that the group member has missed their flight. The travel companion interface 1102 also provides options 1110 for contacting group members. For example, a group member can select an option to call or chat with another group member.

In some implementations, a group member's travel itinerary is analyzed in view of the group member's location to provide more accurate location information in the travel companion interface, as described in reference to FIG. 11. For example, instead of reporting that a group member is “10 minutes away from another group member, the travel companion interface 1102 can indicate that a group member is at a particular location, e.g., “John seems to be at the Red Rooster Pub, as planned in his itinerary” or “Jim is in his hotel.” In some implementations, location data for a group member is analyzed to determine whether the group member is moving or is stationary, and whether certain travel plans were executed or modified. For example, the travel companion interface 1102 can indicate “Sam was at the Louvre for an hour and is moving toward the hotel right now” or “Sam skipped the Louvre and instead went to the Eiffel tower.” In some implementations, locations of group members are determined automatically using a location-aware mobile application. Group members can control the accuracy and detail of location information that is visible to the other group members, e.g., an exact location can be visible or the location can be restricted to identifying a city. Optionally, group members can turn off location reporting. In some implementations, locations are manually provided by group members. Group members have the option to explicitly opt-in to the location-aware mobile application, and may be restricted to viewing locations of group members who have decided to share their location with them.

For situations in which the systems described in this specification collect personal information about users, the users may be provided with an opportunity to opt-out of programs or features that may collect personal information, e.g., information about a user's preferences or a user's location data. User information that is used to identify unique users, unique addresses or other user-related history can be anonymized so that the privacy of users is protected. For example, quasi-unique identifiers can be associated with users, but the actual identifying information of the users is not stored. Additionally, any identified user interactions can be generalized, e.g., generalized based on user demographics, rather than associated with a particular user. Encryption and obfuscation techniques can also be used to protect the privacy of users.

FIG. 12 illustrates an example travel companion map interface 1202 displaying real-time locations of members of a group trip. The travel companion map interface 1202 displays a map including a trip destination and provides locations 1204, 1206, 1208, and 1210 of the group members. In some implementations, locations of group members are indicated using respective thumbnail pictures of the group members.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by a data processing apparatus, the method comprising:
providing, for presentation to a first user on a first client device, a first graphical user interface for scheduling a trip for a travel group;
receiving, through the first graphical user interface on the first client device, user input from the first user specifying trip parameters for organizing the trip, the trip parameters including a trip duration, trip category, and a social group, wherein the social group includes one or more contacts of the user, and wherein the travel group includes as members the user and the one or more contacts in the social group;
providing, for presentation to each member of the travel group on a plurality of second client devices, a second graphical user interface, wherein the second graphical user interface presents data identifying one or more potential time periods for the trip, and wherein the second graphical user interface allows each of the members of the travel group different from the first user that submitted the input specifying the trip parameters to interact with the second graphical user interface to select a time period from the one or more potential time periods;
providing, for presentation to each member of the travel group on the plurality of second client devices, a third graphical user interface, wherein the third graphical user interface presents data identifying one or more potential trip destinations for the trip, the potential trip destinations having been identified based in part on the specified trip duration and trip category, and wherein the third graphical user interface allows each of the members of the travel group different from the first user that submitted the input specifying the trip parameters to interact with the third graphical user interface to select a destination from the one or more potential trip destinations;
receiving, from one or more members of the travel group and through the second and third graphical user interfaces on the second client devices, selections specifying one or more time periods and one or more trip destinations for the trip;
determining, based on the received selections, a particular time period and a particular trip destination for the trip;
generating, for each of the one or more members of the travel group, a respective trip itinerary for the trip at the particular time period and to the particular trip destination, wherein generating the respective trip itinerary for each of the one or more members comprises:
identifying a location associated with the member,
determining one or more transportation options from the location associated with the member to the particular trip destination corresponding to the particular time period, and
generating a trip itinerary for the member that identifies the one or more transportation options from the location associated with the member to the particular trip destination; and
providing, to each of the one or more members, data identifying the respective trip itinerary for the member for presentation on a corresponding one of the second client devices.

2. The method of claim 1, wherein generating, for one or more members of the group, a respective trip itinerary at the particular time period and to the particular trip destination comprises:
receiving, from one or more members of the group, confirmations committing to the trip at the particular time period and the particular trip destination; and
in response to receiving confirmations from the one or more members, generating, for the one or more members, the respective trip itinerary.

3. The method of claim 1, wherein generating, for one or more members of the group, a respective trip itinerary at the particular time period and to the particular trip destination comprises:
identifying one or more members of the group that selected a time period and trip destination that matches both the particular time period and the particular trip destination; and
in response to identifying the one or more members, generating, for the one or more members, the respective trip itinerary for the trip.

4. The method of claim 1, wherein the particular time period and the particular trip destination are determined by the user.

5. The method of claim 1, wherein the particular time period and the particular trip destination are determined based on a respective count of selections received for the particular time period and the particular trip destination.

6. The method of claim 1, wherein the second graphical user interface and the third graphical user interface are a travel planning interface, the travel planning interface including a calendar portion and a potential trip destinations portion, the calendar portion indicating one or more potential time periods for attending the trip, and the potential trip destinations portion describing one or more trip destinations that were identified based on the specified trip duration and trip category.

7. The method of claim 6, wherein the potential trip destinations portion includes, for each of the one or more trip destinations, a respective popularity vote and a respective average travel cost, wherein the respective popularity vote is based on selections received, from one or more members of the group, for the one or more trip destinations.

8. The method of claim 6, wherein the travel planning interface includes a map portion, the map portion indicating locations of the one or more members of the group, and a location of the particular trip destination.

9. The method of claim 8, further comprising:
receiving user input from a member of the group, the user input specifying a new trip destination in the map portion; and
providing data identifying the new trip destination to the one or more members of the group.

10. The method of claim 1, wherein the trip parameters further include a time range, wherein the time range specifies a proposed range of time within which the trip should occur.

11-17. (canceled)

18. A system comprising:
one or more computer-readable storage media having instructions stored thereon; and
data processing apparatus programmed to execute the instructions to perform operations comprising:
providing, for presentation to a first user on a first client device, a first graphical user interface for scheduling a trip for a travel group;
receiving, through flail the first graphical user interface on the first client device, user input from the first user specifying trip parameters for organizing the trip, the trip parameters including a trip duration, trip category, and a social group, wherein the social group includes one or more contacts of the user, and wherein the travel group includes as members the user and the one or more contacts in the social group;
providing, for presentation to each member of the travel group on a plurality of second client devices, a second graphical user interface, wherein the second graphical user interface presents data identifying one or more potential time periods for the trip, and wherein the second graphical user interface allows each of the members of the travel group different from the first user that submitted the input specifying the trip parameters to interact with the second graphical user interface to select a time period from the one or more potential time periods;
providing, for presentation to each member of the travel group on the plurality of second client devices, a third graphical user interface, wherein the third graphical user interface presents data identifying one or more potential trip destinations for the trip, the potential trip destinations having been identified based in part on the specified trip duration and trip category, and wherein the third graphical user interface allows each of the members of the travel group different from the first user that submitted the input specifying the trip parameters to interact with the third graphical user interface to select a destination from the one or more potential trip destinations;
receiving, from one or more members of the travel group and through the second and third graphical user interfaces on the second client devices, selections specifying one or more time periods and one or more trip destinations for the trip;
determining, based on the received selections, a particular time period and a particular trip destination for the trip;
generating, for each of the one or more members of the travel group, a respective trip itinerary for the trip at the particular time period and to the particular trip destination, wherein generating the respective trip itinerary for each of the one or more members comprises:
identifying a location associated with the member,
determining one or more transportation options from the location associated with the member to the particular trip destination corresponding to the particular time period, and
generating a trip itinerary for the member that identifies the one or more transportation options from the location associated with the member to the particular trip destination; and
providing, to each of the one or more members, data identifying the respective trip itinerary for the member for presentation on a corresponding one of the second client devices.

19. The system of claim 18, wherein generating, for one or more members of the group, a respective trip itinerary at the particular time period and to the particular trip destination comprises:
receiving, from one or more members of the group, confirmations committing to the trip at the particular time period and the particular trip destination; and
in response to receiving confirmations from the one or more members, generating, for the one or more members, the respective trip itinerary.

20. The system of claim 18, wherein generating, for one or more members of the group, a respective trip itinerary at the particular time period and to the particular trip destination comprises:
identifying one or more members of the group that selected a time period and trip destination that matches both the particular time period and the particular trip destination; and
in response to identifying the one or more members, generating, for the one or more members, the respective trip itinerary for the trip.

21. The system of claim 18, wherein the particular time period and the particular trip destination are determined by the user.

22. The system of claim 18, wherein the particular time period and the particular trip destination are determined based on a respective count of selections received for the particular time period and the particular trip destination.

23. The system of claim 18, wherein the second graphical user interface and the third graphical user interface are a travel planning interface, the travel planning interface including a calendar portion and a potential trip destinations portion, the calendar portion indicating one or more potential time periods for attending the trip, and the potential trip destinations portion describing one or more trip destinations that were identified based on the specified trip duration and trip category.

24. The system of claim 23, wherein the potential trip destinations portion includes, for each of the one or more trip destinations, a respective popularity vote and a respective average travel cost, wherein the respective popularity vote is based on selections received, from one or more members of the group, for the one or more trip destinations.

25. The system of claim 23, wherein the travel planning interface includes a map portion, the map portion indicating locations of the one or more members of the group, and a location of the particular trip destination.

26. The system of claim 25, further comprising:
receiving user input from a member of the group, the user input specifying a new trip destination in the map portion; and
providing data identifying the new trip destination to the one or more members of the group.

27. The system of claim 18, wherein the trip parameters further include a time range, wherein the time range specifies a proposed range of time within which the trip should occur.

28-30. (canceled)
